(19) United States
(12) Patent Application Publication
(10) Pub. No.: US 2005/0152325 A1
(43) Pub. Date: Jul. 14, 2005

(54) Portable and remotely activated alarm and notification tactile communication device and system

(76) Inventor: Gilbert R. Gonzales, New York, NY (US)

Correspondence Address: WOOD, HERRON & EVANS, LLP, 2700 CAREW TOWER, 441 VINE STREET, CINCINNATI, OH, 45202, US

(21) Appl. No.: 11/034,379

(22) Filed: Jan. 12, 2005

Related U.S. Application Data
(60) Provisional application No. 60/535,881, filed on Jan. 12, 2004.

(51) Int. Cl. H04Q 7/24

(52) U.S. Cl. 370/338

(57) ABSTRACT

A notification system for remotely notifying a user of a message indication at a primary device includes a transmission device configured for coupling with a primary device. The transmission device is configured to detect a message indication of the primary device. The transmission device is further operable to transmit an activation signal. An alarm device is configured to receive the activation signal and tactilely notify a user of the message indication.

### RELATED APPLICATIONS

The application claims the benefit of the priority of U.S. Provisional Application Ser. No. 60/535,881, entitled “Alarm and Notification MEMS Tactile Actuator Device: Portable, Remotely Activated and Distantly Attachable Tactual System Illusion Device and Method,” filed Jan. 12, 2004, which application is incorporated herein by reference in its entirety.

### BACKGROUND OF THE INVENTION

Cell phones, pagers, PDAs, alarm watches and other electronic devices often have combined notification methods that indicate to the user that an event has occurred, such as a phone call or text message has been received. These notification methods or alarm systems include visible light activation (e.g., flashing lights), audible sounds (e.g., phone ringing), and vibration (e.g., vibrating phone) of the device against the body. Oftentimes, the device is carried on a belt or in a pocket or purse. The problems with these notification devices include (1) a visible light, even when flashing, may not be seen if the device is in a pocket, a purse, or out of sight, (2) vibrating devices will not be felt unless they are in direct contact with the user, and (3) audible sounds coming from a device are producing enormous frustration in public places where silence from an audience is demanded (i.e. in concerts, churches and other public places). Furthermore, even these audible notifications may not be heard if the device is in a purse, a pocket, or if the device is activated in a noisy environment.

Furthermore, even when notified, the user has to then pick up and look at the phone or other device to know what the notification is about in order to make a decision of how the notification should be handled (e.g., should the call be answered?).

Therefore, there is still a need for a method of consistently notifying the owner of a device about an event or other action of a user device without perturbing or notifying others that the device owner has been notified. Furthermore, it is desirable that the notification system be non-obtrusive, silent to others and only notify the owner of the device. It would be of further benefit if the notification could be remote from the device itself. It would be further desirable to receive other information about a notification when a device is in a pocket, a purse or other concealed location.

### SUMMARY OF THE INVENTION

The invention is a notification device or system, which uses tactile communication to communicate a notification and other information. In one embodiment, the tactile device is dissociated, or remote, from the actual device that produces the notification, or receives or accesses the message or other information, to which the notification pertains. With the remote tactile device, the invention communicates the activation of the notification to the tactile device wirelessly through radio frequency protocols or systems, such as a Bluetooth system. The tactile device provides to a wearer, a tactile indication of the notification or information. The notification or alarm may simply covertly notify the wearer of the presence of the notification or information in one embodiment, or may actually transmit the information for cutaneous reception and for complex communication through tactual alphanumerics, not as synthetic language; i.e., Braille, but as perceived “writing” on the skin or mucous membrane through non-veridical cutaneous graphics.

### BRIEF DESCRIPTION OF THE DRAWINGS

FIG. 1 is a schematic view of one embodiment of the invention.

FIG. 1A is another schematic view of an embodiment of the invention used in a cell phone.

FIG. 2 is a perspective view of a watch device for incorporating an embodiment of the invention.

FIG. 3 is a schematic view of an alternative embodiment of the invention in a cell phone.

### DETAILED DESCRIPTION OF THE INVENTION

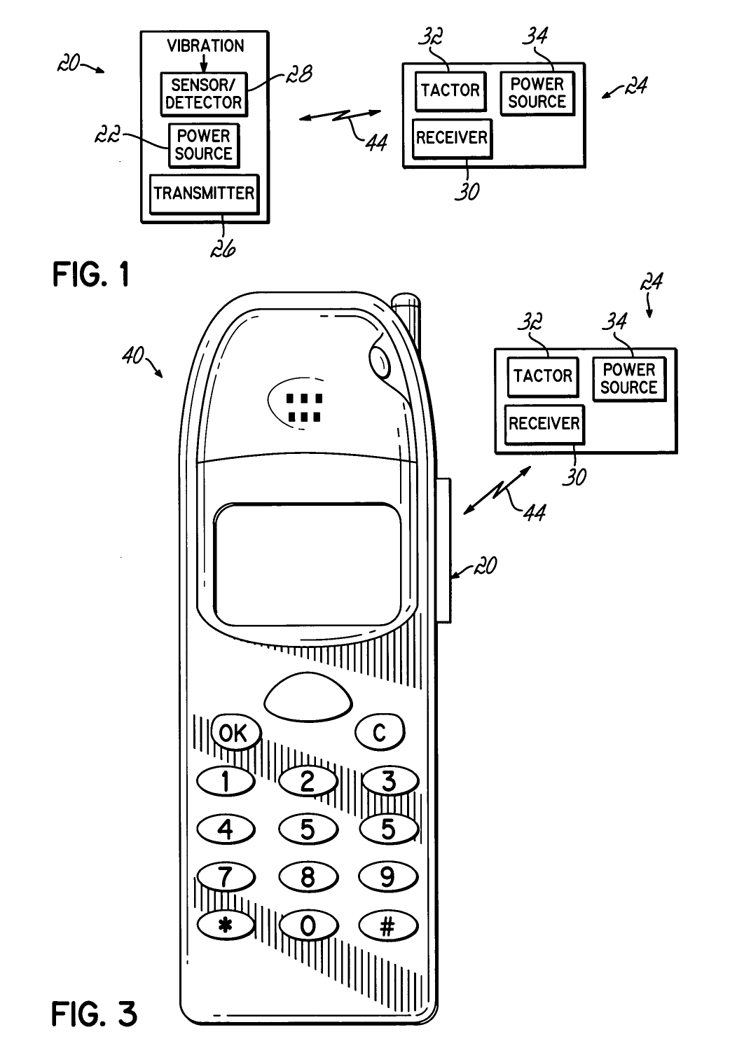

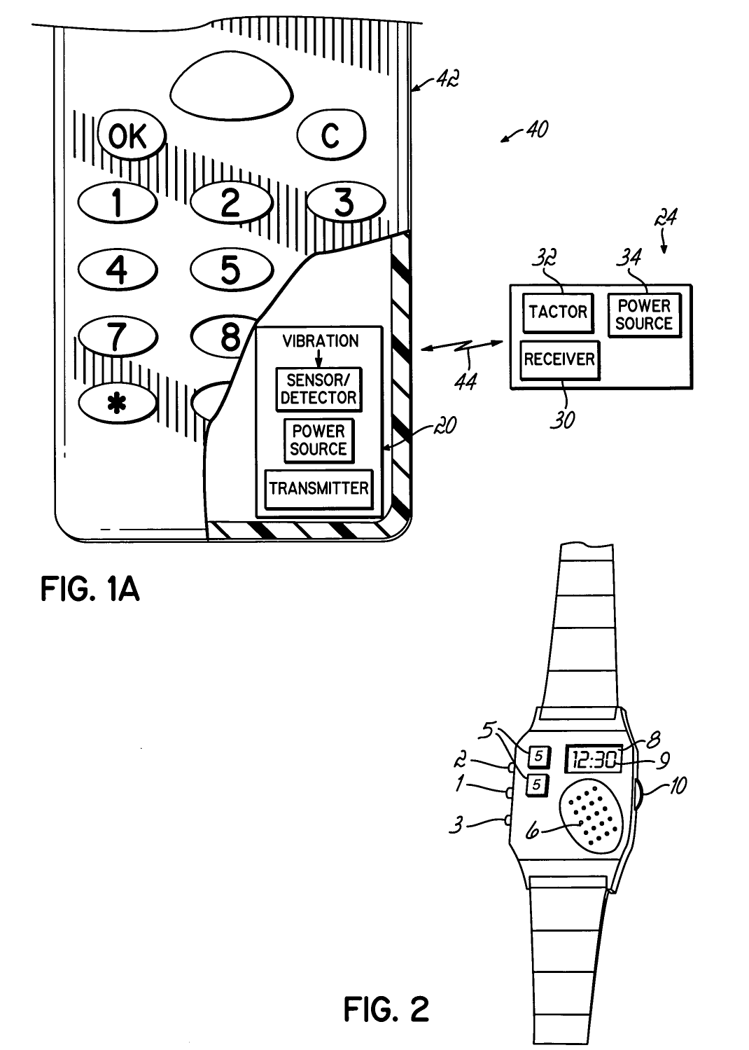

As illustrated in FIG. 1, one embodiment of the present invention provides a self-contained tactile notification and alarm device system. A transmission device 20 may couple with or be attached to a primary device, such as a cell phone, PDA, pager, etc. (see FIGS. 2A, 3). The transmission device 10 includes independent power sources 22, 23 that allows the transmission device 20 to function autonomously. The alarm device has a similar independent power source 34. A wireless transmitter 26 in the transmission device 20 transmits to and activates the alarm device 24. The transmission device 20 also includes a sensor/detector 28 operable to sense a ring, a vibration or another signal from the primary device that indicates that the primary device has an event and is creating a notification such as a call or message. At the alarm device 24, a reception device or receiver 30 directs the alarm device 24 to activate the tactile actuators, or tactor(s). At least one tactor on the alarm device is activated to notify the wearer that a message, information, a call or some other event has occurred.

In one embodiment, the transmission device 20 is an autonomous device that can be coupled externally (FIG. 3) or internally (FIG. 1A) with the primary device 40, such as a mobile phone. In FIG. 1A, the transmission device 24 is shown mounted internally as one of the cell phone components. That is, the functionality of the transmission device 20 is incorporated into the electronics of the primary device and is not a separate system. However, the transmission device 24 may also be a separate system and adhered onto the casing 42 or form wrapped around an internal or external component with suitable attachment means or methods.

The alarm device 24, in the embodiment illustrated in FIG. 1A, is remote from the primary device 40. The alarm device includes the suitable receiver 30 for wireless communications 44 with the primary device 40 and its associated transmission device 20 and transmitter 26. The wireless connection 44 may be any suitable wireless connection, such as a Bluetooth connection, or other RF connection, as discussed further below.

The alarm device 24 includes one or more tactors, such as a plurality or array of tactors, which are used to notify a user or wearer of an event at the primary device. For example, the tactors may be any suitable actuators for tactile communication, including vibromechanical, pneumatic, ultrasonic, shape memory alloy, piezo-electric, ceramic bimorph, firmo-actuating, or micro-electrical mechanical systems, for example. Various such tactile communication devices and their operation are described in U.S. Pat. Nos. 5,719,561 and 6,326,901, both entitled “Tactile Communication Device and Method” and both patents being incorporated herein by reference in their entireties. The tactors, or array of tactors, are utilized to provide a tactile indication, to the wearer, of the notification received from the transmission device. The tactilely communicated notification, in turn, notifies the wearer of an event at the primary device, such as the ringing or vibration of a cell phone. In another embodiment of the invention, not only is the notification provided, but also an alpha/numeric tactile communication is provided, such as text, so that the name of a caller, or a text message, at the primary device 40, might also be provided as a communication to the user.

The primary device 40 may be set on the “quiet”, or vibration mode and when the primary device 40 is set off or activated by an incoming telephone call, it then vibrates. The vibration of the primary device 40 activates a sensor/detector 28 in the transmission device 20 or primary device 40, which then transmits a suitable wireless activation signal 44, such as in the Bluetooth frequency range to the alarm device 24. The activation signal 44 is then received by the alarm device 24 that, in turn, activates the tactors 32 and stimulates the skin, such as through repeated vibration, or other suitable action. This then notifies the wearer that a message or telephone call has been received.

The sensor/detector 28 of the transmission device 20 may be any suitable sensor or detector that can sense a signal, condition, or event in the primary device 40, such as a cell phone, and then provide an output that can then be used for the purposes of transmitting an activation signal to the alarm device 24 to provide a tactile notification to the wearer. For example, the sensor detector might be a microelectrical mechanical system (MEMS) detector that is capable of detecting a vibration. As such, the sensor detector device 28 might be directly coupled to the vibrating element of the phone. Alternatively, sensor/detector 28 might be configured to capture a ringing signal, such that when a phone is ringing, sensor/detector 28 senses the ringing and provides a suitable output for generating a wireless activation signal 44 to the alarm device. In still another embodiment, the sensor detector 28 might be configured to monitor any one of a number of internal signals in a primary device, such as a signal indicating an incoming call, a signal sent to an indicator light, or any other number of signals that are reflective of an event at the primary device, such as a waiting or ongoing call or message. As such, the present invention is not limited to the type of sensor detector, or the type of event that is captured by the sensor detection of the transmission device 20.

The primary device 40 may be a large number of communication, data and other information electronic devices but one preferred device to utilize this system will be a mobile telephone as noted. In another embodiment of the invention, multiple primary devices could also be connected to a single or multiple transmission devices 24, although a single transmission device and primary device are shown in the Figures.

One preferable transmission device is a flat, thin rectangular “chip” shaped device no more than 7 mm by 9 mm in size. Under certain circumstances a larger device would be indicated or even multiple devices connected to a single primary device. The transmission device is coupled with or attaches to the primary device and is activated by the primary device, as described. It then transmits formation and remotely activates the alarm device.

The alarm device 24 preferably would be as small as possible and yet still be able to deliver tactile communication forces sufficient to be felt tactually by the wearer on most body surfaces. The alarm device 24 may be adhered or attached to multiple surfaces including, for example, the back of watches, on the wrist band of a watch, on the handles of eyeglasses, on jewelry such as bracelets, rings and necklaces, on clothing (such as attached by safety pins), and in shoes, etc. One preferred article would be on the back of a watch or on the wristband of a watch, as shown in FIG. 2.

In addition to an array of MEMS actuators, the tactors 32 used for the transmission device 24 may include solenoids, piezo benders, piezo ceramic bimorphs, mechanical actuators, shape memory allow, pneumatic actuators, direct pneumatics, and electrical stimulation and many other cutaneous and mucous membrane stimulators, for example.

FIG. 3 illustrates an alternative embodiment of the invention wherein a primary device 40, such as a cell phone, utilizes a transmission device 20 and alarm device 24 in accordance with the principles of the present invention. However, rather than having a transmission device 20 incorporated internally into the primary device 40 as illustrated in FIG. 1A, the transmission device 20 might be added as a retrofit element onto a phone. In that way, phones without Bluetooth or other wireless capabilities might be utilized with the present invention.

Referring again to FIG. 1A, the transmission device 20 is illustrated as a separate component to the cell phone. However, in an alternative embodiment of the invention, the transmission device 20 might be internally incorporated as part of the operating system and electronics of the cell phone or other primary device. For example, the transmission device 20 or its functions might be incorporated into an existing Bluetooth functionality of a primary device, such as a cell phone, rather than as a stand-alone transmission device. As such, the primary device would still have the capability of transmitting a wireless activation or other signal 44 to an alarm device 24 and the ability to detect an event, such as a vibration or a ring, in order to provide a notification to the alarm device.

As noted above, in one embodiment of the invention, a simple stimulation provided by the alarm device, specifically by the tactors or tactile elements 32 of the alarm device may be sufficient to indicate to a user that a call is incoming, or a message is waiting, or any other number of existing events in the primary device. However, in another embodiment of the invention, a tactile communication device, such as an array of tactors, as described in U.S. Pat. Nos. 5,719,561 and 6,326,901 might be utilized. In that way, the alarm device may provide a more complex message, such an alphanumeric text message to a user. In that way, the user knows something about the event, rather than just knowing that an event at the primary device exists.

For example, the present invention may provide a text message to the user or wearer that indicates the name of the person calling, as obtained from caller ID by the transmission device 20. As such, the transmission device 20 or transmission components of the primary device 40 may be further operably coupled with the operating system of the primary device to obtain the extra information. In another embodiment, if the event is a text message, the alarm device may be actuated appropriately by the transmission device 20 or the primary device 40 to actually play the text message in a tactile communication fashion as is described in the above-referenced patents. For sending the additional information, the wireless activation signal will carry additional information rather than that information for just turning the tactors 32 ON/OFF. Instead, the receiver 30 will have the functionality to use the actuation signal and provide a text message with tactors 32.

As noted, one method of transmission between the transmission device and alarm device is by Bluetooth method.

Bluetooth devices operate at 2.4 GHz in the globally available, license-free ISM band. This band is reserved for general use by Industrial, Scientific, and Medical (ISM) applications, which obey a basic set of power and spectral emission and interference specifications. This means that Bluetooth has to be very robust, as there are a great many existing users and polluters of this shared spectrum.

The operating band is divided into 1 MHz-spaced channels, each signaling data at 1 Mega symbol per second so as to obtain the maximum available channel bandwidth. With the chosen modulation scheme of GFSK (Gaussian Frequency Shift Keying), this equates to 1 Mb/s. Using GFSK, a binary 1 gives rise to a positive frequency deviation from the nominal carrier frequency, while a binary 0 gives rise to a negative frequency deviation.

After each packet, both devices retune their radio to a different frequency, effectively hopping from radio channel to radio channel (FHSSC frequency hopping spread spectrum). In this way, Bluetooth devices use the whole of the available ISM band and if a transmission is compromised by interference on one channel, the retransmission will always be on a different (hopefully clear) channel. Each Bluetooth time slot lasts 625 microseconds, and, generally, devices hop once per packet, which will be every slot, every 3 slots, or every 5 slots.

Designed for low-powered portable applications, the radio power must be minimized. Three different power classes are defined, which provide operation ranges of approximately 10 m, 20 m, and 100 m; the lowest power gives up to 10 m range, the highest up to 100 m.

In addition to Bluetooth as a method of wireless transmission between the device and the notification system, other low frequency and VLF and VHF radio signals may be used. Alternatively, magnetic hysteresis, inaudible sound, infrared, ultrasound and other energy sources could be used for the wireless link 44 and to generate the necessary actuator signal.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of applicant's general inventive concept.

1. A system for providing a notification to a user of an event at a primary device, the system comprising:
a transmission device configured for interfacing with a primary device to detect an event at the primary device;
the transmission device, upon detecting an event, transmitting an activation signal;
an alarm device configured to receive the activation signal and provide a tactile notification to the user of the event.

2. The system of claim 1 wherein the transmission device is coupled to the primary device.

3. The system of claim 1 wherein the transmission device is incorporated into the primary device.

4. The system of claim 1 wherein the transmission device includes a sensor for detecting the event, the sensor detecting at least one of a ring or vibration.

5. The system of claim 1 wherein the transmission device transmits a wireless activation signal, the alarm device including a wireless receiver to receive the activation signal.

6. The system of claim 5 wherein the wireless activation signal is a Bluetooth signal.

7. The system of claim 1 wherein the activation signal includes information about the detected event, the alarm device further configured to provide a tactile notification to the user that includes the information about the event.

8. The system of claim 7 wherein the alarm device is configured to provide a tactile alphanumeric message that includes information about the event.

9. An electronic device capable of providing a notification to a user of an event, the device comprising:
a transmission component configured for detecting an event in the electronic device and transmitting an activation signal;
an alarm device, remote from the electronic device, and configured to receive the activation signal and provide a tactile notification to the user of the event.

10. The device of claim wherein the transmission component includes a sensor for detecting the event.

11. The device of claim 9 wherein the transmission component transmits a wireless activation signal, the alarm device including a wireless receiver to receive the activation signal.

12. The device of claim 11 wherein the wireless activation signal is a Bluetooth signal.

13. The device of claim 9 wherein the activation signal includes information about the detected event, the alarm device further configured to provide a tactile notification to the user that includes the information about the event.

14. The device of claim 13 wherein the alarm device is configured to provide a tactile alphanumeric message that includes information about the event.

15. A method for providing a notification to a user of an event at a primary device, the method comprising:
detecting an event in a primary device upon detecting the event, transmitting an activation signal to an alarm device;
providing a tactile notification to the user of the event with the alarm device when it receives the activation signal.

16. The method of claim 15 further comprising transmitting a wireless activation signal.

17. The method of claim 16 further comprising transmitting a Bluetooth activation signal.

18. The method of claim 15 further comprising transmitting an activation signal that includes information about the detected event and providing a tactile notification to the user that includes the information about the event.

19. The method of claim 15 further comprising providing a tactile alphanumeric message that includes information about the event to the user.
